(19) United States
(12) Patent Application Publication
(10) Pub. No.: US 2008/0109381 A1
(43) Pub. Date: May 8, 2008

(54) Private equity fund valuation and due diligence analysis system and method with deal-level benchmark

(76) Inventor: Oliver Gottschalg, Frankfurt (DE)

Correspondence Address: Donald W. Meeker;Patent Agent, 924 East Ocean Front #E, Newport Beach, CA, 92661, US

(21) Appl. No.: 11/591,877

(22) Filed: Nov. 2, 2006

(51) Int. Cl. G06Q 40/00

(52) U.S. Cl. 705/36 R

(57) ABSTRACT

Private equity fund valuation and due diligence analysis software that combines available information on private equity funds, the organizations and individuals managing these funds, the underlying deals for these funds and companies comparable to the deals for these funds and utilizes multivariate statistical regression or other possible analysis techniques to develop highly accurate approximate deal-level performance benchmarks, value driver analyses, fund-level performance forecasts and fund rating scores. These analyses allow investors to assess the attractiveness of an investment into a given private equity fund with a much greater level of detail.

### CROSS-REFERENCE TO RELATED APPLICATIONS

This application claims the benefit of U.S. Provisional Patent Application No. 60/586,986, filed on Nov. 2, 2005.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to financial analysis tools to value private equity fund investments and to assess the quality of private equity fund managers based on a variety of quantitative analyses and performance benchmarks. The tool allows investors to assess the attractiveness of an investment into a given private equity fund with a much greater level of detail based on several analysis including following. One element of this tool is a system and method to combine available information on fund-level performance and the characteristic of underlying deals for these funds that utilizes for example multivariate statistical regression or other possible analysis techniques to develop highly accurate approximate deal-level benchmarks. A second element of this tool is a system and method to combine available information on the historic cash flow pattern of private equity funds and the characteristics of these funds at different points in time, the underlying deals for these funds and the characteristics of the fund managers over time that utilizes multivariate statistical regression or other possible analysis techniques to forecast expected future returns to these funds at a high level of accuracy. A third element of this tool is a system and method to combine data on the financial performance, accounting performance and capital structure of a focal private equity deals with the financial performance, accounting performance and capital structure of comparable publicly traded or privately held companies to use mathematical calculations to quantify the performance impact of different value drivers in the focal private equity deal and to benchmark these with comparable figures for the comparable companies.

2. Description of Related Art Including Information Disclosed Under 37 CFR 1.97 and 1.98

Investors in the financial community currently assess the past performance of private equity fund managers by comparing average fund-level performance to commercially available average fund performances. No data on average deal-level performance is currently commercially available, as such data is confidential.

The accurate selection of private equity fund managers is as crucial for the performance of one's private equity portfolio as it is challenging. Data paucity, few benchmarking possibilities and the long time lag between commitment decisions and performance outcomes in the past have made private equity fund due diligence still look more like an art than a science.

U.S. Patent Application #20060143105, published Jun. 29, 2006 by Coates, describes portable alpha-plus financial products having a private equity component. The financial product includes a cash component, an alpha engine component, a private equity component and a beta component. The cash component includes an investment in a liquid portfolio. The alpha engine component includes an investment in an alpha-generating portfolio. The private equity component includes an investment in the private equity portfolio. The beta component is structured to track a total return of one or more indices.

U.S. Patent Application #20030028467, published Feb. 6, 2003 by Sanborn, claims a method and system of raising online venture capital in the private equity and debt markets, for raising capital for early stage, primarily privately held, companies through a broker-dealer and private funds which attempts to maximize the number of investors and a low per unit investment cost to provide wider participation in the private equity market while promoting diversification of risk. Because of the need to limit costs associated with managing such small funds, investment criteria would often be tied to due diligence undertaken by third parties or to pre-set, objective criteria.

U.S. Patent Application #20040148248, published Jul. 29, 2004 by Allen, discloses a facility that provides information about and enables secondary transfers of restricted interests in issuers. A method is provided that includes receiving from users, buy or sell orders, each of the buy or sell orders being for an amount of an identified restricted interest to be subjected to a secondary transfer at a proposed value, and displaying the buy and sell orders for review by online or offline users. Implementations of the invention may include one or more of the following features. The restricted interests comprise interests in limited partnerships. The restricted interests comprise interests in private companies. Information is displayed about an issuer of the restricted interest. Permission of the issuer of the restricted interest is obtained to display the information about the issuer. The proposed value is expressed relative to an asset value associated with the interest. The proposed value is expressed as a percentage of the net asset value of the interest. The proposed value takes account of characteristics of the issuer of the interest. The proposed value takes account of historic information associated with the issuer or the interest. The proposed value takes account of market conditions. The amount of the identified restricted interest represents a funded commitment and an unfunded commitment. The online users comprise potential buyers and sellers of restricted interests. The online users comprise an issuer of the restricted interest.

U.S. Patent Application #20060100946, published May 11, 2006 by Kazarian, indicates a co-investment structure that aligns interests among investors and investment managers by creating pure performance based compensation for the investment manager while overcoming the conundrum facing asset allocators in selecting investment managers. The co-investment structure provides cash-based evaluation of performance and offers multi-option hurdle rate alternatives that accommodate the performance benchmarks of major asset classes while establishing a compensation structure using granular stratification of relative performance. The co-investment structure bases investment manager compensation solely on excess profits, actually cultivating entrepreneurial returns. In particular, the best entrepreneurial investment managers, singularly focused on achieving excess profit with respect to a top quartile benchmark, excel with the co-investment structure. A table of exemplary data comparing hurdle rate over historical periods is shown. The table includes a comparison of five commonly used benchmarks with a hedge fund index over four consecutive time periods. The table also includes a comparison of five benchmarks with a private equity index over four consecutive time periods. The specific percentages indicate the returns or performance required to be within the top quartile. Such data is used by fiduciaries in an effort to properly distribute assets under management.

U.S. Patent Application #20050171883, published Aug. 4, 2005 by Dundas, puts forth a method and system for asset allocation. The method and system matches an investor's objectives for portfolio investment return and risk with an assessment of a range of expected returns and risks that are likely to be generated by investment portfolios consisting at least in part of alternative asset classes that involves, for example, selecting available historical data for a plurality of alternative asset classes, unsmoothing the historical data based at least in part on historical data for traditional asset classes related to the respective alternative asset classes, and correcting the historical data for the alternative asset classes for an impact of survivorship and selection biases. A forecast of an expected return and risk is computed for each of the alternative asset classes, based at least in part on the unsmoothed and corrected historical data for the alternative asset classes, and at least one of the alternative asset classes that has an expected return and risk that corresponds substantially to the investor's objectives for portfolio investment return and risk is identified for inclusion in the investment portfolio.

U.S. Patent Application #20040249687, published Dec. 9, 2004 by Lowell, concerns, a system and method of evaluating investment fund manager performance including collecting career information for a plurality of investment fund managers, collecting fund information for a plurality of investment funds across a fund universe, associating the career information of an investment fund manager to the fund information for related investment funds to generate career performance information for each of the plurality of investment fund managers, determining a group of investment fund managers based on at least one criterion, comparing the career performance information of at least one member of the group to a benchmark to generate at least one career performance record, and analyzing the at least one career performance record.

U.S. Patent Application #20050187866, published Aug. 25, 2005 by Lee, illustrates a web-based method and system that facilitates business transactions, including the raising of capital in global financial markets via the Internet. Users of the system design, structure, analyze and execute business transactions over the Internet. Users of the system described include issuers, financial institutions, intermediaries, other professional advisors (law firms, accounting firms, translation agencies, etc.) and end investors. A security means controls access to the system and restricts access to the system to only qualified users. Users of the system design and diagram a transaction structure, assign corresponding attributes to the structure design. The structure design and corresponding attributes are stored in a database. The transaction is posted as a notice or interest onto the system, wherein a user maintains the posting. A database of user and transaction information is compiled and maintained. The user profile is compared with the posted transactions to identify transactions of interest to a user. The transaction information is communicated to the user. The transaction is executed, including issuing new securities or buying or selling previously issued securities through an auction or trade process. The system provides users direct access to its community, which includes, but is not limited to, issuers, investors, intermediaries, and advisors such as law firms, consultancy firms, accounting firms, and translation agents.

Two U.S. Patent Applications, #20050144135 published Jun. 30, 2005 and #20050131830 published Jun. 16, 2005 by Juarez, claim a private entity profile network for private equity and debt funding operations, wherein resource providers define electronic data collection templates to be filled in by prospective resource consumers to form semi-homogeneous profiles. Providers and/or consumers can assign themselves and/or third parties various individualized levels of permissions to access and to perform activities on the profiles. Providers can organize profiles into portfolios to further manage the data. All accesses and activities, such as changes to the data, are tracked and recorded in logs useful for audit purposes.

U.S. Patent Application #20060167777, published Jul. 27, 2006 by Shkedy, describes a method and apparatus for determining investment manager skill. The method of evaluating an investment manager's skill includes determining a time frame including a plurality of time periods of a predefined duration over which to calculate statistics, generating a return distribution for each time period, obtaining return data for a manager for each given time period, standardizing the manager's return data for each given time period, and calculating measurement statistics to compare the manager's return data against the return distribution over the plurality of time periods.

What is needed is a system and method to combine available information on private equity funds, the underlying investments of these funds, the organizations and individuals who manage these funds, publicly traded or privately held firms with characteristics that are similar to the underlying investment of these funds into a financial analysis tools to value private equity fund investments and to assess the quality of private equity fund managers based on a variety of quantitative analyses and performance benchmarks.

### BRIEF SUMMARY OF THE INVENTION

An object of the present invention is to provide a system and method to combine available information on private equity funds, the underlying investments of these funds, the organizations and individuals who manage these funds, publicly traded or privately held firms with characteristics that are similar to the underlying investment of these funds into a financial analysis tools to value private equity fund investments and to assess the quality of private equity fund managers based on a variety of quantitative analyses and performance benchmarks. The tool allows investors to assess the attractiveness of an investment into a given private equity fund with a much greater level of detail.

In brief, the present invention relates to an analysis system and method for a private equity (PE) fund valuation due diligence tool including deal-level benchmark, performance forecasting, value decomposition and fund rating functionality.

The overall method comprises the following components: data on fund-level performance (e.g. the underlying cash flows) for PE funds over time—commercially available from different sources; data on deal-level PE fund investment characteristics over time (e.g. the transaction dates, investment stage, size, age, industry of the acquired company etc.)—commercially available from different sources; data on PE fund characteristics (e.g. size, strategic focus etc.)—commercially available from different sources; data on PE fund manager characteristics (e.g. team size and composition, capital under management, age etc.)—commercially available from different sources; stock market, company and accounting data of publicly traded companies—commercially available from different source; a statistical model to calculate “deal-level performance coefficients” for the performance impact of different deal-characteristics; software or method to calculate deal-level benchmark based on the deal-level performance coefficients; a statistical model to calculate “historic payoff pattern coefficients” for the impact of historic PE fund characteristics on future and final PE fund performance; software or method to forecast approximate future and final PE fund performance based on the historic payoff pattern coefficients; a statistical model to calculate “fund rating coefficients” for the impact of prior PE fund and PE fund manager characteristics measured at the time of fundraising for a focal fund on future and final performance of that focal fund; software or method to forecast approximate future and final performance of a focal fund based on the fund rating coefficients as a fund rating device; software or method to measure the selection efficiency of a given method to select PE funds from a pool of PE funds offered to investors based on an analysis of the average portfolio performance realized through this method with (a) the average performance of all PE funds offered to investors and (b) the average ex-post performance of the best x % of the PE funds offered to investors; software or method to decompose equity returns from public equity or private equity investments into the following four components: revenue growth effect, margin effect, multiple expansion effect, leverage effect; software or method to compare (benchmark) the equity returns from PE investments to comparable investments in publicly traded or privately held in terms of (a) overall equity returns, (b) revenue growth effect, (c) margin effect, (d) multiple expansion effect, (e) leverage effect; a method to ‘browse’ conveniently through a large number of due diligence analyses for a given PE fund that allows (a) changing the unit of analysis (e.g. moving from the portfolio-level to the fund-level to the deal-level) within each type of analysis and (b) switching from one type of analysis to another type of analysis (e.g. moving from the PE deal-level benchmark to the value decomposition analysis) within one level of analysis demo of the Private Equity fund valuation and due diligence Tool that it uses HTML programming to allow the users to ‘browse conveniently’ through the analysis. In doing so, users can chose one type of analysis (Deal-Level PE Performance Benchmark, PE Fund Performance Forecaster, Value Decomposition Analysis, Value Decomposition Benchmark or PE Fund Rating Analysis) and then changing the unit of analysis (e.g. moving from the portfolio-level to the fund-level to the deal-level) within each type of analysis. Alternatively they can stay at a given level of analysis (i.e. fund III) and switch one type of analysis to another type of analysis (e.g. moving from the PE deal-level benchmark to the value decomposition analysis).

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a diagrammatic view of a table showing data on fund performance;

FIG. 2 is a diagrammatic view of a table showing data on deal characteristics of private equity funds;

FIG. 3 is a diagrammatic view of a table showing a combination of input data on fund-level performance for private equity funds over time and on deal-level private equity fund investment characteristics over time;

FIG. 4 is a diagrammatic view of a table showing an output of statistical analysis on deal-level performance coefficients;

FIG. 5 is a diagrammatic view of a flow chart of the deal-level benchmark methodology of the present invention;

FIG. 6 is a diagrammatic view of a table showing data on fund performance and characteristics over time;

FIG. 7 is a diagrammatic view of a table showing a combination of input data on fund-level performance for private equity funds over time, on deal-level private equity fund investment characteristics over time, and on private equity fund characteristics;

FIG. 8 is a diagrammatic view of a table showing an output of statistical analysis as historic payoff pattern coefficients;

FIG. 9 is a diagrammatic view of a flowchart showing the methodology for a private equity fund performance forecaster;

FIG. 10 is a diagrammatic view of a table showing data on historical fundraising situations;

FIG. 11 is a diagrammatic view of a timeline using data from past fundraising situations;

FIG. 12 is a diagrammatic view of a table showing an output of statistical analysis as fund rating coefficients;

FIG. 13 is a diagrammatic view of a flowchart showing the methodology for private equity fund rating;

FIG. 14 is a diagrammatic view of a graph showing fund selection IRR comparison.

### DETAILED DESCRIPTION OF THE INVENTION

The present invention comprises a system method employing a software program as a private equity (PE) fund valuation and due diligence tool including deal-level benchmark, performance forecasting, value decomposition and fund rating functionality. The tool allows investors to assess the attractiveness of an investment into a given private equity fund with a much greater level of detail.

A private equity fund valuation and due diligence system including deal-level benchmark, performance forecasting, value decomposition and fund rating functionality, the system comprising a software program providing a valuation and due diligence analysis tool using hyper text markup language programming to allow a user to browse through an analysis choosing one type of analysis taken from the list of types of analysis including deal-level private equity performance benchmark analysis, private equity fund performance forecaster analysis, value decomposition analysis, value decomposition benchmark analysis, and private equity fund rating analysis and to change the unit of analysis switching from one level of analysis to another between the levels of analysis including the portfolio-level analysis, the fund-level analysis, and the deal-level analysis within each type of analysis and alternatively to stay at one level of analysis and switch one type of analysis to another type of analysis.

In detail, the private equity fund valuation and due diligence system including deal-level benchmark, performance forecasting, value decomposition and fund rating functionality, the system comprises:

a software program with a series of data gathering and analysis programs for use as a private equity (PE) fund valuation and due diligence tool including deal-level benchmark, performance forecasting, value decomposition and fund rating functionality, the system comprising the following components:

(1) data on fund-level performance for private equity funds over time;

(2) data on deal-level private equity fund investment characteristics over time;

(3) data on private equity fund characteristics;

(4) data on private equity fund manager characteristics;

(5) stock market, company and accounting data of comparable publicly traded or privately held companies;

(6) a statistical model for calculating deal-level performance coefficients for the performance impact of different deal-characteristics;

(7) a program for calculating a deal-level benchmark based on deal-level performance coefficients;

(8) a statistical model for calculating historic payoff pattern coefficients for the impact of historic private equity fund characteristics on future and final private fund performance;

(9) a program for forecasting approximate future and final private equity fund performance based on the historic payoff pattern coefficients;

(10) a statistical model for calculating fund rating coefficients for the impact of prior private equity fund and private equity fund manager characteristics measured at the time of fundraising for a focal fund on future and final performance of that focal fund;

(11) a program for forecasting approximate future and final performance of a focal fund based on the fund rating coefficients as a fund rating device;

(12) a program for measuring the selection efficiency of a given method to select private equity funds from a pool of private equity funds offered to investors based on an analysis of the average portfolio performance realized with (a) the average performance of all PE funds offered to investors and (b) the average ex-post performance of the best percentage of the PE funds offered to investors;

(13) a program for decomposing equity returns from public equity or private equity investments into the following four components: revenue growth effect, margin effect, multiple expansion effect, and leverage effect;

(14) a program for performing benchmark comparisons of the equity returns from private equity investments to comparable public equity investments in terms of (a) overall equity returns, (b) revenue growth effect, (c) margin effect, (d) multiple expansion effect, and (e) leverage effect to provide deal-level benchmarks; and

(15) a program for browsing through a large number of due diligence analyses for a given private equity fund, the program for browsing allowing changing the unit of analysis within each type of analysis and switching from one type of analysis to another type of analysis within one level of analysis.

Based on these components, the following analyses, described below in more detail, will be performed: Deal-Level PE Performance Benchmark, PE Fund Performance Forecaster, Value Decomposition Analysis, Value Decomposition Benchmark, PE Fund Rating Analysis.

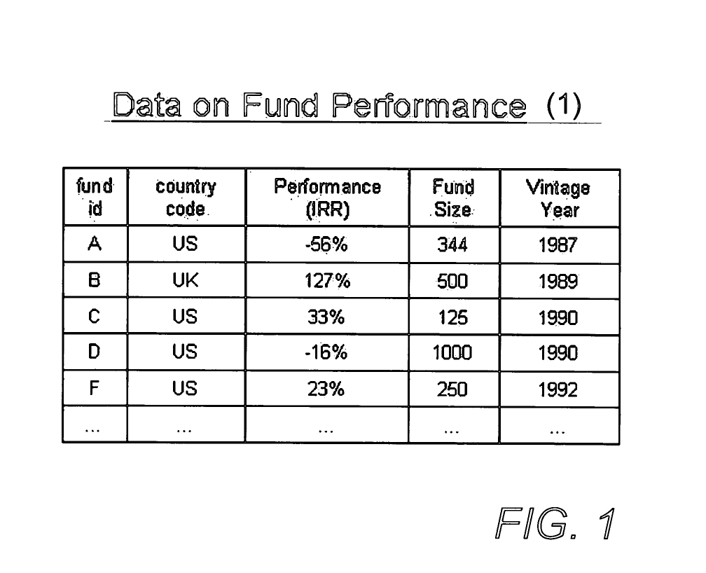

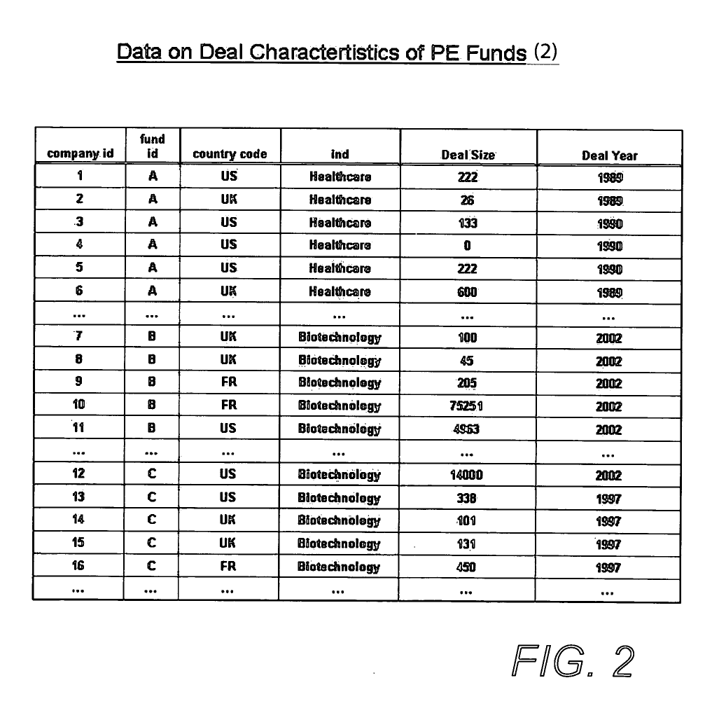

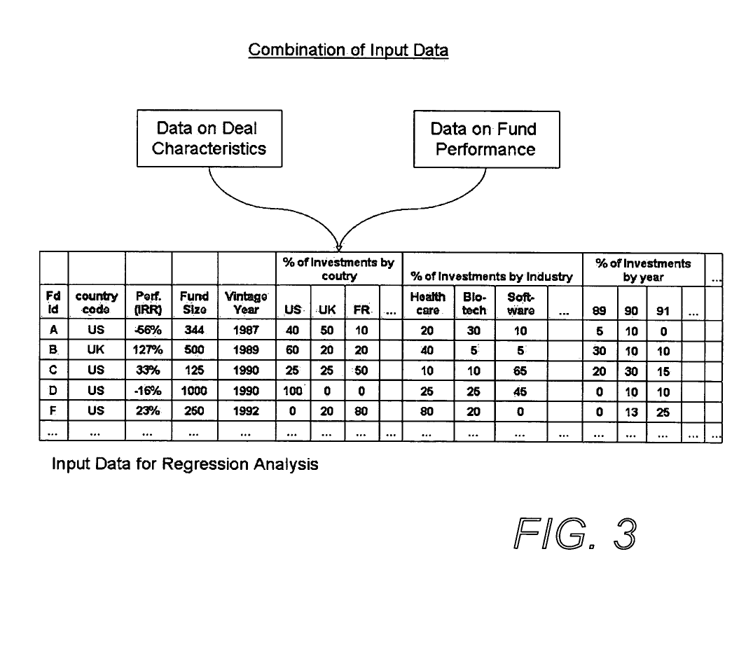

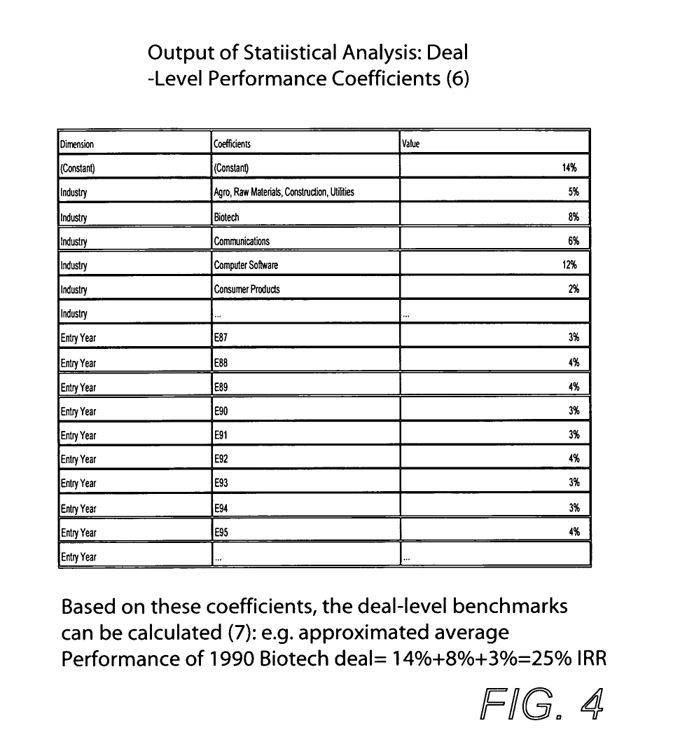

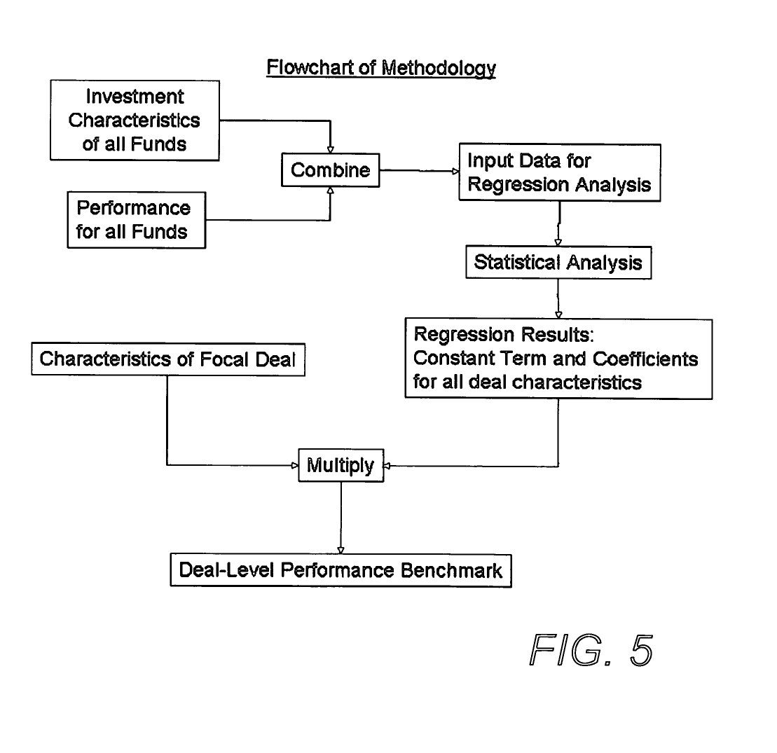

For the Deal-Level PE Performance Benchmark, the “deal-level performance coefficients” (6) that measure the performance impact of different deal-characteristics on PE Fund performance, in FIG. 4, are calculated based on the data from paragraphs (1) and (2) above, in FIGS. 1 and 2 and combined in FIG. 3, using standard statistical software package (e.g. SPSS or Stata); then these deal-level performance coefficients are used to calculate the deal-level PE performance benchmark, using either a simple Excel sheet or a specific software program of paragraph (7) above according to the flowchart of FIG. 5. Based on these coefficients, the deal-level benchmarks can be calculated (7): e.g. approximated average Performance of 1990 Biotech deal=14%+8%+3%=25% IRR.

One could use the same main idea: combining fund-level performance and deal-level investment characteristics to approximate deal-level performance using different statistical techniques.

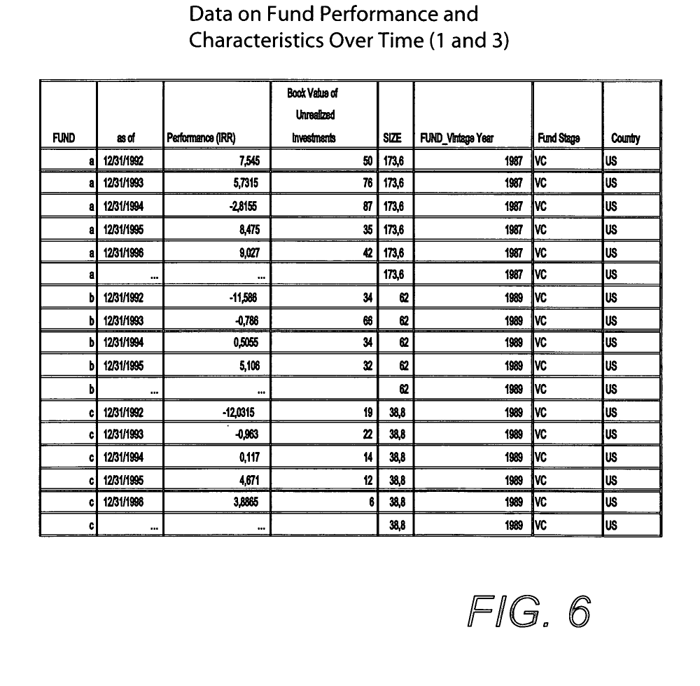

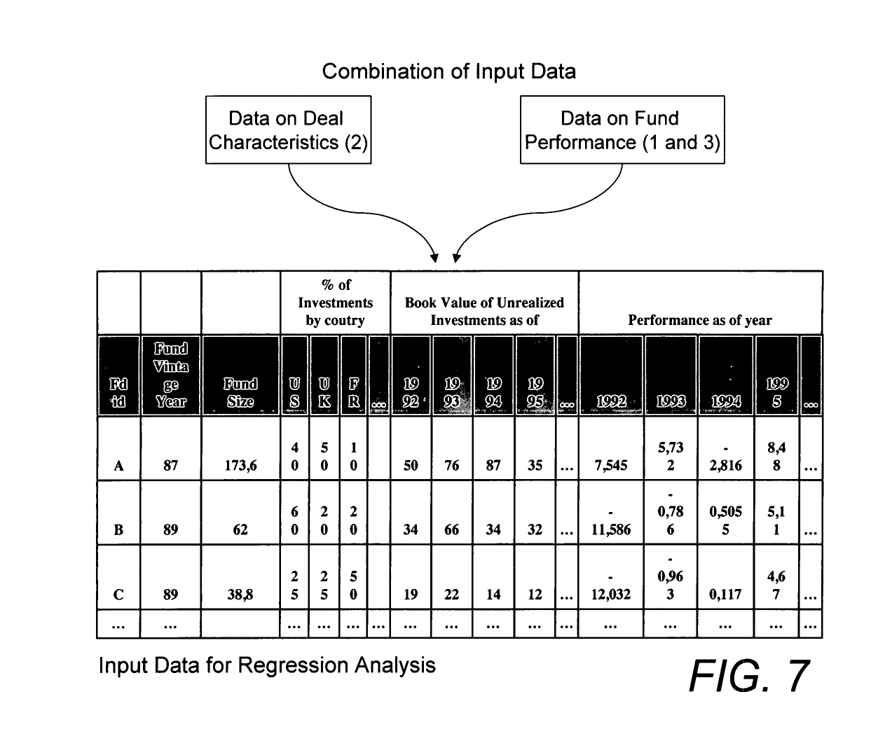

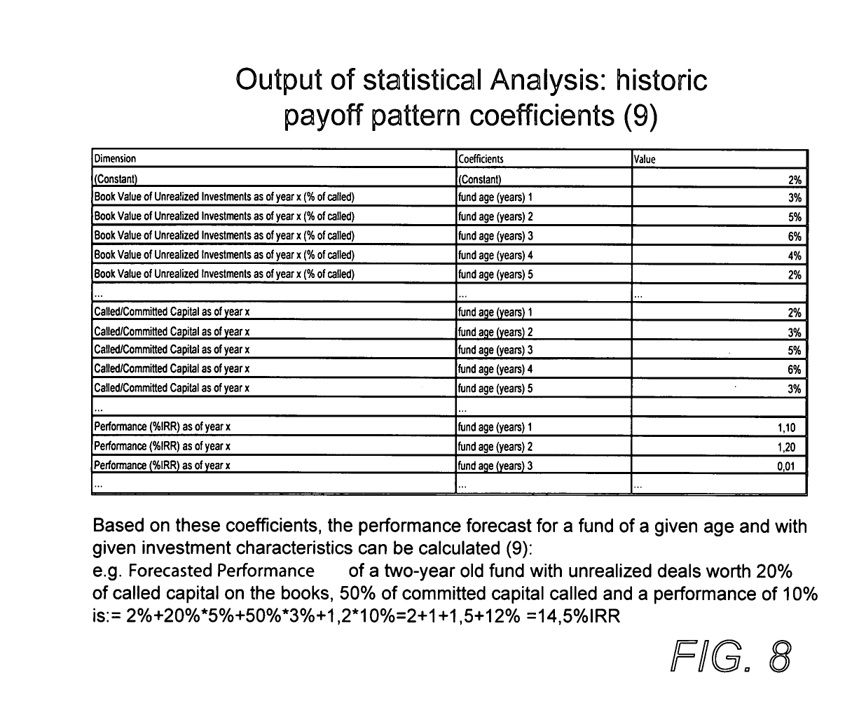

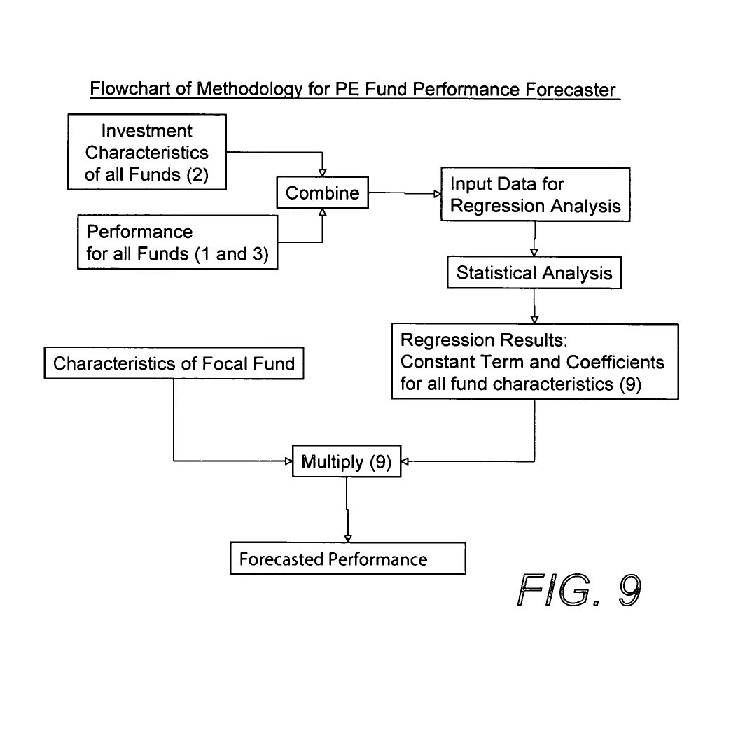

For the PE Fund Performance Forecaster, the “historic payoff pattern coefficients” that measure the impact of historic PE fund characteristics on future and final PE fund performance are calculated based on the data from paragraphs (1), (2) and (3) above, as shown combined in FIG. 7, by combining the data of paragraph (1) and (3), as shown in FIG. 6 with the data of paragraph (2), as shown in FIG. 2, using standard statistical software package (e.g. SPSS or Stata); then these historic payoff pattern coefficients are used to forecast the performance of PE funds with given characteristics using either a simple Excel sheet or a specific software program of paragraph (9) above, as shown in FIG. 8 according to the method of the flowchart of FIG. 9.

Based on these coefficients, the performance forecast for a fund of a given age and with given investment characteristics can be calculated (9):

e.g. Forecasted Performance of a two-year old fund with unrealized deals worth 20% of called capital on the books, 50% of committed capital called and a performance of 10% is:=2%+20%*5%+50%*3%+1,2*10%=2+1+1,5+12%=14,5% IRR

One could use the same main idea: combining historic fund-level characteristics and final performance of a pool of PE funds to forecast PE fund performance using different statistical techniques.

For the Value Decomposition Analysis, the change equity value of a business can be broken down into the following four determinants (13): revenues, margin, valuation multiple and net debt. The following formulae are based in part on an article co-authored by the present inventor (“Working out where the value lies”, European Venture Capital Journal, June 2004 (O. Gottschalg, N. Loos, M. Zollo)) although the present invention goes beyond the article in integrating the formulae as a small part of the system and method of the present invention with applications and many elements not found in the article. Using compounded annual growth rates (CAGRs) of all four components, the IRR (as the CAGR of the equity value) can be expressed as:

(1+(CAGR(E))=(1+(CAGR(Re)))(1+(CAGR(EBITDA/Rev)))(1+CAG((EV/EBITDA)))(I+(CAGR(E/EV)))

with (1+CAGR(E)) being equivalent to 1+IRR(Equity). To understand what portion of the overall IRR is determined by each of these components, calculate:

$$100 \% = ( ln ( 1 + ( CAGR ( Rev ) ) ) / ln ( 1 + CAGR ( E ) ) ) + ( ln ( 1 + CAGR ( EBITDA / Rev ) ) ) / ln ( 1 + ( CAGR ( E ) ) ) + ( ln ( 1 + ( CAGR ( ( EV / EBITDA ) ) ) / ln ( 1 + CAGR ( E ) ) ) + ln ( 1 + ( CAGR ( E / EV ) ) / ln ( 1 + ( CAGR ( E ) ) )$$

with (1+CAGR(E)) being equivalent to 1+IRR(Equity). To understand what portion of the overall IRR is determined by each of these components, we can calculate:

$$IRR ( Equity ) = IRR ( Equity ) ( ln ( I + ( CAGR ( Rev ) ) ) / ln ( 1 + ( CAGR ( E ) ) ) + IRR ( Equity ) ( ln ( 1 + ( CAGR ( EBITDA / Rev ) ) ) / ln ( 1 + ( CAGR ( E ) ) ) + IRR ( Equity ) ( ln ( 1 + CAGR ( ( EV / EBITDA ) ) ) / ln ( 1 + ( CAGR ( E ) ) ) + IRR ( Equity ) ( ln ( 1 + ( CAGR ( E / EV ) ) ) / ln ( 1 + ( CAGR ( E ) ) )$$

These values can be interpreted in the following way:

$$IRR ( Equity ) = Revenue growth effect ( on IRR ) + EBITDA margin effect ( on IRR ) + Multiple expansion effect ( on IRR ) + Leverage Effect ( on IRR ) .$$

Each bracket now represents the relative contribution of revenues growth, margin improvement, multiple expansion and leverage to IRR, adding up to 100%. By multiplying both sides with the equity IRR, we find each factor's absolute contribution to the level of IRR, hence

These values can be interpreted in the following way:

$$IRR ( Equity ) = Revenue growth effect ( on IRR ) + EBITDA margin effect ( on IRR ) + Multiple expansion effect ( on IRR ) + Leverage Effect ( on IRR ) .$$

For the Value Decomposition Benchmark, the Value Decomposition Analysis as described above is performed for one (or multiple) PE investment and one or a sample of comparable publicly traded (‘peer’) companies (using data from (5)). The comparison in each of the four value drivers (Revenue growth effect, Margin effect, Multiple expansion effect, Leverage Effect.) between these two for a given time period makes it possible to determine to what extent element of the value change of the PE investment is related to changes in the corresponding value driver of the publicly traded peer(s) (14).

Provided data is available, a comparison with one or multiple comparable PE investments in each value driver is equally possible.

The Private Equity fund valuation and due diligence Tool of the present invention provides its user with many charts and analyses.

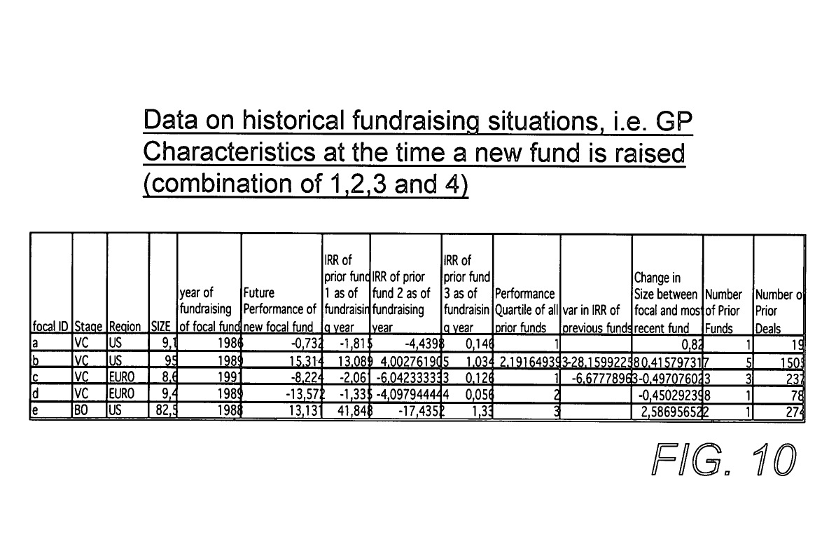

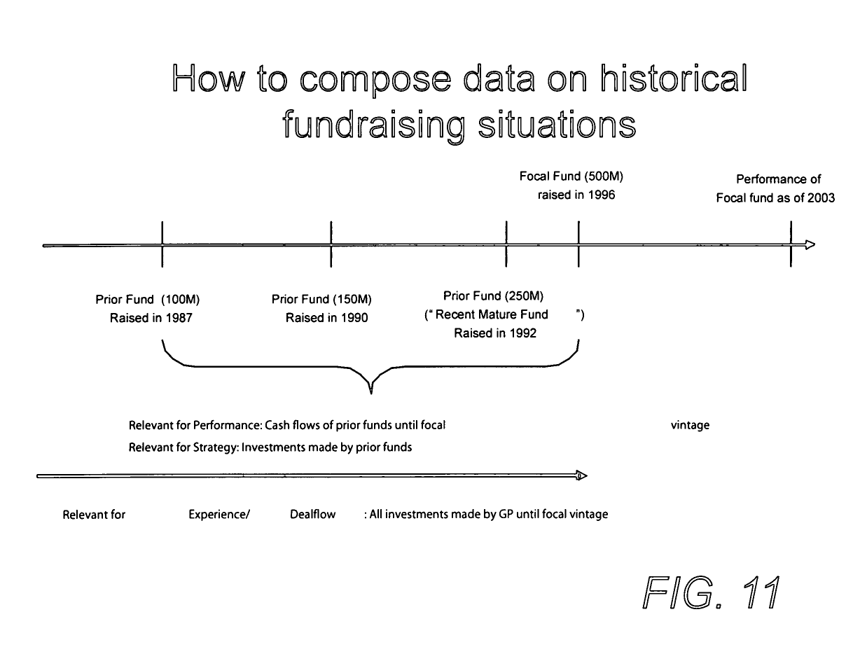

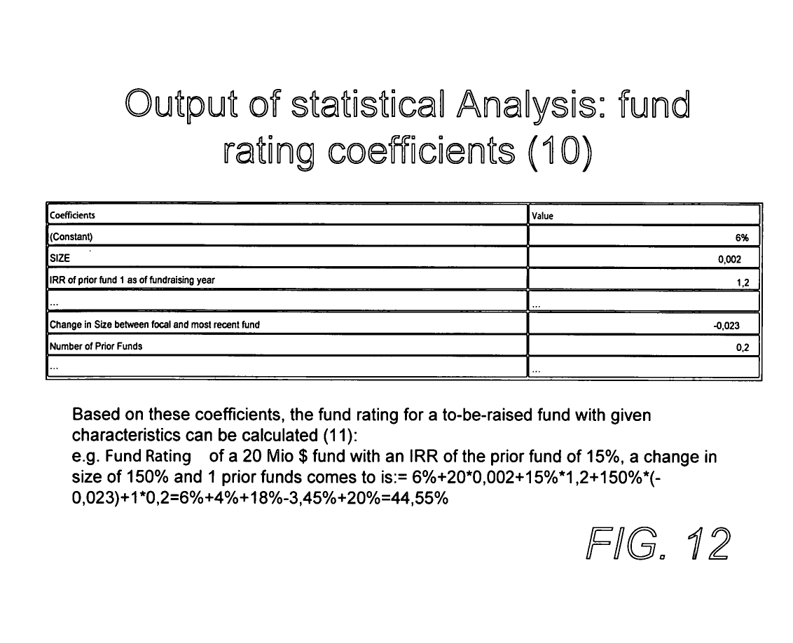

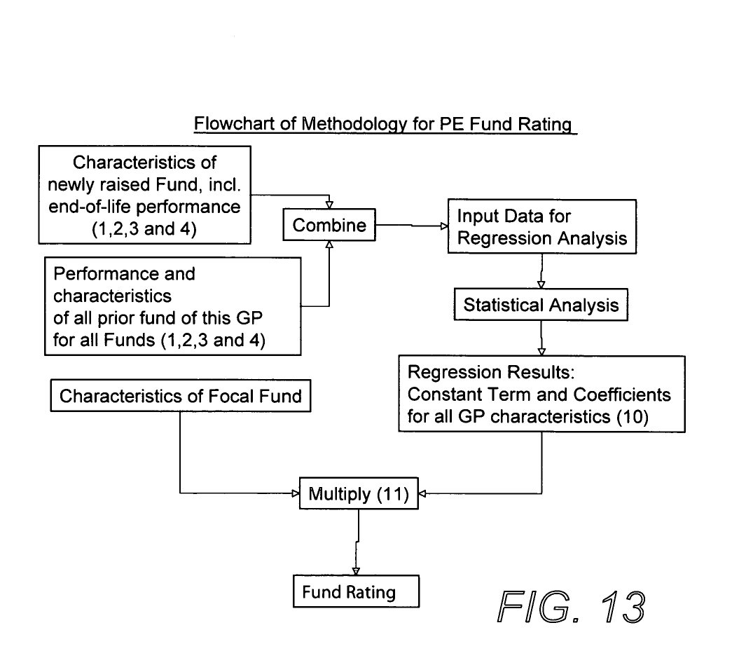

For the PE Fund Rating Analysis, several of the previous analyses are combined and, together with other ratios, used to derive a rating scheme for PE funds. Looking at historic data on PE funds managed by a given PE fund manager, as in paragraphs (1), (2), (3) and (4) above, as of the moment in time when a new (focal) fund was raised by this fund manager, as seen in FIGS. 10 and 11, the present invention statistically links a number of measures of PE fund and PE fund manager characteristics, including past performance (including measures based on the Deal-Level PE Performance Benchmark, the PE Fund Performance Forecaster, the Value Decomposition Analysis and the Value Decomposition Benchmark), strategy, team resources and experience, to the later performance of these focal funds. This can be done, for example, through a multivariate regression or other possible analysis of the PE fund and PE fund manager characteristics measured at the time a focal fund is raised on the later performance of these focal funds that estimates the ‘fund rating coefficients’ of paragraph (10) above, as shown in FIG. 12; then these fund rating coefficients are used to estimate the expected performance of a focal PE fund with given Fund and fund manager characteristics at fundraising using either a simple Excel sheet or a specific software program of paragraph (11) above as illustrated in the flowchart of FIG. 13.

Based on these coefficients, the fund rating for a to-be-raised fund with given characteristics can be calculated (11):

e.g. Fund Rating of a 20 Mio $ fund with an IRR of the prior fund of 15%, a change in size of 150% and 1 prior funds comes to is:=6%+20*0,002+15%*1,2+150%*(−0,023)+1*0,2=6%+4%+18%-3,45%+20%=44,55%.

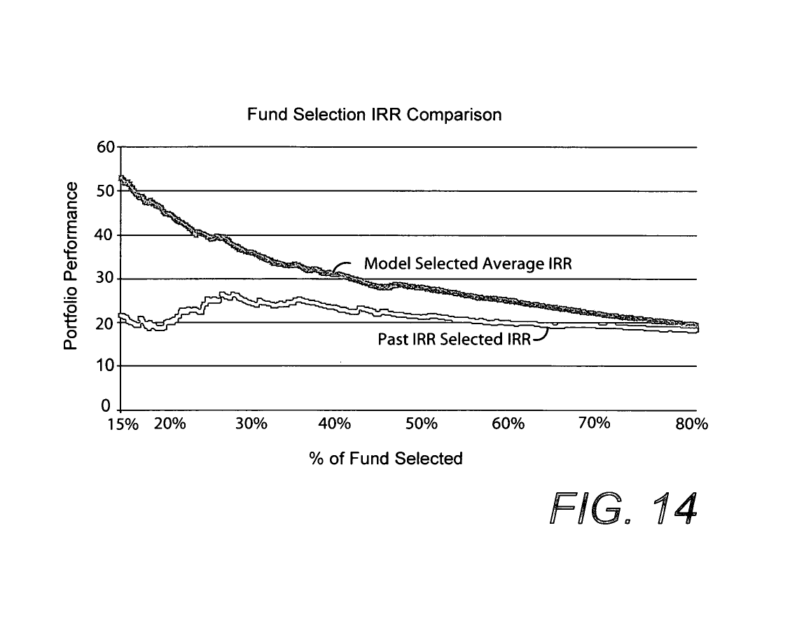

In FIG. 14, the efficiency of a given method (for example based on a particular version of the PE Fund Rating Analysis) to select PE funds from a pool of PE funds offered to investors (13) is measured as the ratio of (a) and integral of the difference between the average performance of all PE funds offered to investors and the average performance of the best x % of the PE funds as predicted by the selection method (b) integral of the difference between the average performance of all PE funds offered to investors and the average performance of the actual best x % (ex-post) of the PE funds offered to investors.

In case of a typical Fund Due Diligence process, in which several previous funds, each with between 10 and 100 investments are being analyzed, the number of charts can be several hundred. To guide the use through this ‘jungle’ of information, a particular logic has been developed. It uses HTML programming to allow the users to ‘browse conveniently’ through the analysis (15). In doing so, they can chose one type of analysis (Deal-Level PE Performance Benchmark, PE Fund Performance Forecaster, Value Decomposition Analysis, Value Decomposition Benchmark or PE Fund Rating Analysis) and then changing the unit of analysis (e.g. moving from the portfolio-level to the fund-level to the deal-level) within each type of analysis. Alternatively they can stay at a given level of analysis (i.e. fund III) and switch one type of analysis to another type of analysis (e.g. moving from the PE deal-level benchmark to the value decomposition analysis).

Example of Use of the Private Equity Fund Valuation and Due Diligence Tool: Currently potential investors into PE funds typically analyze the fund proposed to them based on a limited number of analyses that have several shortcomings. (a) They mostly focus on aggregate fund-level performance only: imagine a given fund that made 20 investments with an average yearly performance of 20%, then this will be compared to the average fund-level performance of all funds raised in the same year (e.g. 15%) to conclude that this is a good fund. (b) More detailed analyses of individual deals and value drivers often occur manually, ad hoc and with little possibility to benchmark the reported performance figures (it is private equity and little to no disclosure requirements exist). The Private Equity Fund Valuation and Due Diligence Tool enables them to use all the information on the performance and characteristics of the 20 individual investments in the sample and compare them in detail to average (public or private equity) investments that happened in the same industry, are of comparable size and/or happened during the same year etc. My technique furthermore quantifies the characteristics of a proposed fund in a fund rating scheme that makes it possible to easily compare the attractiveness of different funds and to assess the selection efficiency to alternative fund selection rules.

In use, a private equity fund valuation and due diligence method including deal-level benchmark, performance forecasting, value decomposition and fund rating functionality, comprises using a software program to serve as a due diligence tool using hyper text markup language programming to allow a user to browse through an analysis choosing one type of analysis taken from the list of types of analysis including deal-level private equity performance benchmark analysis, private equity fund performance forecaster analysis, value decomposition analysis, value decomposition benchmark analysis, and private equity fund rating analysis and to change the unit of analysis switching from one level of analysis to another between the levels of analysis including the portfolio-level analysis, the fund-level analysis, and the deal-level analysis within each type of analysis and alternatively to stay at one level of analysis and switch one type of analysis to another type of analysis.

In detail the private equity fund valuation and due diligence method including deal-level benchmark functionality comprises the following steps:

A first step of gathering data on fund-level performance for private equity funds over time, the step comprising gathering data on the private equity fund cash flows.

A second step of gathering data on deal-level private equity fund investment characteristics over time, the step comprising gathering data on the investment characteristics of transaction dates, stage, age, size, country and industry sector.

A third step of gathering data on private equity fund characteristics, the step comprising gathering data on the equity fund characteristics of region, vintage year, size and investment focus.

A fourth step of gathering data on private equity fund manager characteristics, the step comprising gathering data on the equity fund manager characteristics of team size, team composition, biographical data of investment managers, capital under management, and age.

A fifth step of gathering stock market, company and accounting data of publicly traded companies.

A sixth step of using a statistical model to calculate deal-level performance coefficients for the performance impact of different deal-characteristics.

A seventh step of calculating a deal-level benchmark based on deal-level performance coefficients, the step comprising using a software program to calculate a deal-level benchmark.

An eighth step of using a statistical model to calculate historic payoff pattern coefficients for the impact of historic private equity fund characteristics on future and final private fund performance.

A ninth step of forecast approximate future and final private equity fund performance based on the historic payoff pattern coefficients, the step comprising using a software program to calculate a deal-level benchmark based on deal-level performance coefficients, the step comprising using a software program to forecast approximate future and final private equity fund performance.

A tenth step of using a statistical model to calculate fund rating coefficients for the impact of prior private equity fund and private equity fund manager characteristics measured at the time of fundraising for a focal fund on future and final performance of that focal fund.

An eleventh step of forecasting approximate future and final performance of a focal fund based on the fund rating coefficients as a fund rating device, the eleventh step comprising using a software program to forecast approximate future and final performance of a focal fund.

A twelfth step of measuring the selection efficiency of a given method to select private equity funds from a pool of private equity funds offered to investors based on an analysis of the average portfolio performance realized through this method with (a) the average performance of all PE funds offered to investors and (b) the average ex-post performance of the best percentage of the PE funds offered to investors, the step comprising using software to measure the selection efficiency.

A thirteenth step of decomposing equity returns from public equity or private equity investments into the following four components: revenue growth effect, margin effect, multiple expansion effect, and leverage effect, the step comprising using a software program to decompose equity returns.

A fourteenth step of performing benchmark comparisons of the equity returns from private equity investments to comparable public equity investments in terms of (a) overall equity returns, (b) revenue growth effect, (c) margin effect, (d) multiple expansion effect, and (e) leverage effect, the step comprising using a software program to compare the equity returns from private equity investments to comparable public equity investments.

A fifteenth step of using a method of browsing through a large number of due diligence analyses for a given private equity fund, the method of browsing allowing changing the unit of analysis within each type of analysis and switching from one type of analysis to another type of analysis within one level of analysis, wherein changing the unit of analysis comprises moving from the portfolio-level to the fund-level to the deal-level within each type of analysis, and wherein switching from one type of analysis to another type of analysis comprises moving from a private equity deal-level benchmark to a value decomposition analysis within one level of analysis.

The method comprises using a software program to run statistical models using non-linear multivariate regression or other possible analysis to calculate various performance measures and benchmarks for proposed private equity fund investments.

The method comprises using a software program which uses various commercially available data sources on performance of private equity funds, stock market, business and accounting data on publicly traded firms and on the characteristics of the investments private equity funds have made and on the fund managers responsible for the investments. The method further comprises using a software program to measure historic cash flows of private equity funds and using a software program to analyze the characteristics of industry sector, industry size, and time of the investments private equity funds have made and the fund managers responsible for the investments.

It is understood that the preceding description is given merely by way of illustration and not in limitation of the invention and that various modifications may be made thereto without departing from the spirit of the invention as claimed.

What is claimed is:

1. A private equity fund valuation and due diligence analysis method including deal-level benchmark, performance forecasting, value decomposition and fund rating functionality, the method comprising using a software program to serve as a valuation and due diligence tool using hyper text markup language programming to allow a user to browse through an analysis choosing one type of analysis taken from the list of types of analysis including deal-level private equity performance benchmark analysis, private equity fund performance forecaster analysis, value decomposition analysis, value decomposition benchmark analysis, and private equity fund rating analysis and to change the unit of analysis switching from one level of analysis to another between the levels of analysis including the portfolio-level analysis, the fund-level analysis, and the deal-level analysis within each type of analysis and alternatively to stay at one level of analysis and switch one type of analysis to another type of analysis to provide a private equity fund valuation and due diligence analysis method including deal-level benchmark, performance forecasting, value decomposition and fund rating functionality.

2. A private equity fund valuation and due diligence analysis method including deal-level benchmark, performance forecasting, value decomposition and fund rating functionality, the method comprising:
a first step of gathering data on fund-level performance for private equity funds over time;
a second step of gathering data on deal-level private equity fund investment characteristics over time;
a third step of gathering data on private equity fund characteristics;
a fourth step of gathering data on private equity fund manager characteristics;
a fifth step of gathering stock market, company and accounting data of publicly traded companies;
a sixth step of using a statistical model to calculate deal-level performance coefficients for the performance impact of different deal-characteristics;
a seventh step of calculating a deal-level benchmark based on deal-level performance coefficients;
an eighth step of using a statistical model to calculate historic payoff pattern coefficients for the impact of historic private equity fund characteristics on future and final private fund performance;
a ninth step of forecast approximate future and final private equity fund performance based on the historic payoff pattern coefficients;
a tenth step of using a statistical model to calculate fund rating coefficients for the impact of prior private equity fund and private equity fund manager characteristics measured at the time of fundraising for a focal fund on future and final performance of that focal fund;
an eleventh step of forecasting approximate future and final performance of a focal fund based on the fund rating coefficients as a fund rating device;
a twelfth step of measuring the selection efficiency of a given method to select private equity funds from a pool of private equity funds offered to investors based on an analysis of the average portfolio performance realized through this method with (a) the average performance of all PE funds offered to investors and (b) the average ex-post performance of the best percentage of the PE funds offered to investors;
a thirteenth step of decomposing equity returns from public equity or private equity investments into the following four components: revenue growth effect, margin effect, multiple expansion effect, and leverage effect;
a fourteenth step of performing benchmark comparisons of the equity returns from private equity investments to comparable public equity investments in terms of (a) overall equity returns, (b) revenue growth effect, (c) margin effect, (d) multiple expansion effect, and (e) leverage effect to provide deal-level benchmarks; and
a fifteenth step of using a method of browsing through a large number of due diligence analyses for a given private equity fund, the method of browsing allowing changing the unit of analysis within each type of analysis and switching from one type of analysis to another type of analysis within one level of analysis;
all combined to provide a private equity fund valuation and due diligence analysis method including deal-level benchmark, performance forecasting, value decomposition and fund rating functionality.

3. The method of claim 2 wherein step three comprises gathering data on the equity fund characteristics of size and strategic focus.

4. The method of claim 2 wherein the fourth step comprises gathering data on the equity fund manager characteristics of team size, team composition, capital under management, and age.

5. The method of claim 2 wherein the seventh step comprises using a software program to calculate a deal-level benchmark based on deal-level performance coefficients.

6. The method of claim 2 wherein the ninth step comprises using a software program to forecast approximate future and final private equity fund performance based on the historic payoff pattern coefficients.

7. The method of claim 2 wherein the eleventh step comprises using a software program to forecast approximate future and final performance of a focal fund based on the fund rating coefficients as a fund rating device.

8. The method of claim 2 wherein the twelfth step comprises using software to measure the selection efficiency.

9. The method of claim 2 wherein the thirteenth step comprises using a software program to decompose equity returns.

10. The method of claim 2 wherein the fourteenth step comprises using a software program to compare (benchmark) the equity returns from private equity investments to comparable public equity investments.

11. The method of claim 2 wherein changing the unit of analysis in the fifteenth step comprises moving from the portfolio-level to the fund-level to the deal-level within each type of analysis.

12. The method of claim 2 wherein switching from one type of analysis to another type of analysis comprises moving from a private equity deal-level benchmark to a value decomposition analysis within one level of analysis.

13. The method of claim 2 wherein the method comprises using a software program to run statistical models using analysis techniques to calculate various performance measures and benchmarks for proposed private equity fund investments.

14. The method of claim 2 wherein the method comprises using a software program which uses various commercially available data sources on performance of private equity funds, stock market, business and accounting data on publicly traded firms and on the characteristics of the investments private equity funds have made and on the fund managers responsible for the investments.

15. The method of claim 14 wherein the method comprises using a software program to measure historic cash flows of private equity funds.

16. The method of claim 14 wherein the method comprises using a software program to analyze the characteristics of industry sector, industry size, and time of the investments private equity funds have made and the fund managers responsible for the investments.

17. A private equity fund valuation and due diligence system including deal-level benchmark, performance forecasting, value decomposition and fund rating functionality, the system comprising a software program providing a due diligence analysis tool using hyper text markup language programming to allow a user to browse through an analysis choosing one type of analysis taken from the list of types of analysis including deal-level private equity performance benchmark analysis, private equity fund performance forecaster analysis, value decomposition analysis, value decomposition benchmark analysis, and private equity fund rating analysis and to change the unit of analysis switching from one level of analysis to another between the levels of analysis including the portfolio-level analysis, the fund-level analysis, and the deal-level analysis within each type of analysis and alternatively to stay at one level of analysis and switch one type of analysis to another type of analysis to provide a private equity fund valuation and due diligence system including deal-level benchmark, performance forecasting, value decomposition and fund rating functionality.

18. A private equity fund valuation and due diligence system including deal-level benchmark, performance forecasting, value decomposition and fund rating functionality, the system comprising:
a software program with a series of data gathering and analysis programs for use as a private equity (PE) fund valuation and due diligence tool including deal-level benchmark, performance forecasting, value decomposition and fund rating functionality, the system comprising the following components:
a program for gathering data on fund-level performance for private equity funds over time;
a program for gathering data on deal-level private equity fund investment characteristics over time;
a program for gathering data on private equity fund characteristics;
a program for gathering data on private equity fund manager characteristics;
a program for gathering stock market, company and accounting data of publicly traded companies;
a statistical model for calculating deal-level performance coefficients for the performance impact of different deal-characteristics;
a program for calculating a deal-level benchmark based on deal-level performance coefficients;
a statistical model for calculating historic payoff pattern coefficients for the impact of historic private equity fund characteristics on future and final private fund performance;
a program for forecasting approximate future and final private equity fund performance based on the historic payoff pattern coefficients;
a statistical model for calculating fund rating coefficients for the impact of prior private equity fund and private equity fund manager characteristics measured at the time of fundraising for a focal fund on future and final performance of that focal fund;
a program for forecasting approximate future and final performance of a focal fund based on the fund rating coefficients as a fund rating device;
a program for measuring the selection efficiency of a given method to select private equity funds from a pool of private equity funds offered to investors based on an analysis of the average portfolio performance realized with (a) the average performance of all PE funds offered to investors and (b) the average ex-post performance of the best percentage of the PE funds offered to investors;
a program for decomposing equity returns from public equity or private equity investments into the following four components: revenue growth effect, margin effect, multiple expansion effect, and leverage effect;
a program for performing benchmark comparisons of the equity returns from private equity investments to comparable public equity investments in terms of (a) overall equity returns, (b) revenue growth effect, (c) margin effect, (d) multiple expansion effect, and (e) leverage effect to provide deal-level benchmarks; and
a program for browsing through a large number of due diligence analyses for a given private equity find, the program for browsing allowing changing the unit of analysis within each type of analysis and switching from one type of analysis to another type of analysis within one level of analysis;
all combined to provide a private equity fund valuation and due diligence system including deal-level benchmark, performance forecasting, value decomposition and fund rating functionality.
